(19) United States
(12) Patent Application Publication
(10) Pub. No.: US 2014/0002563 A1
(43) Pub. Date: Jan. 2, 2014

(54) PRINTER ENCLOSURE

(71) Applicant: YI-LONG LEE, Tu-Cheng (TW)

(72) Inventor: YI-LONG LEE, Tu-Cheng (TW)

(73) Assignee: HON HAI PRECISION INDUSTRY CO., LTD., Tu-Cheng (TW)

(21) Appl. No.: 13/565,783

(22) Filed: Aug. 2, 2012

(30) Foreign Application Priority Data
Jun. 27, 2012 (TW) 101123103

(51) Int. Cl. B41J 29/13

(52) U.S. Cl. 347/108

(57) ABSTRACT

A printer enclosure includes printer, a cover, and a window. A printing portion and a paper tray are secured to a side of the printing portion. The printing portion is adapted to print a paper. The paper tray is adapted to receive the paper after the paper is printed. The printing portion defines a printing space and an opening. The cover is secured to the printing portion and defines an installation opening. The window is mounted in the installation opening and faces the opening. The printing space in the printing portion is visible through the window and the opening.

### BACKGROUND

1. Technical Field

The present disclosure relates to enclosures, and particularly a printer enclosure.

2. Description of Related Art

Generally, a printer includes a printing portion. The printing portion includes a plurality of printing members for printing papers. When papers are jammed in the printing portion or there is something wrong with the plurality of printing members, users should open a cover of the printer to find where the papers or wrong printing members are, which is inconvenient and time consuming. Furthermore, the users often discover problems after the wrong pictures have been outputted from the printer, which is a waste of paper and ink. Therefore, an improved printer enclosure may be desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a printer enclosure.

FIG. 2 is an isometric view of a cleaning assembly of the printer enclosure of FIG. 1.

FIG. 3 is an assembled, isometric view of the printer enclosure of FIG. 1.

FIG. 4 is similar to FIG. 3, but viewed from a different aspect, and with a partially cutaway view of the assembled printer enclosure of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

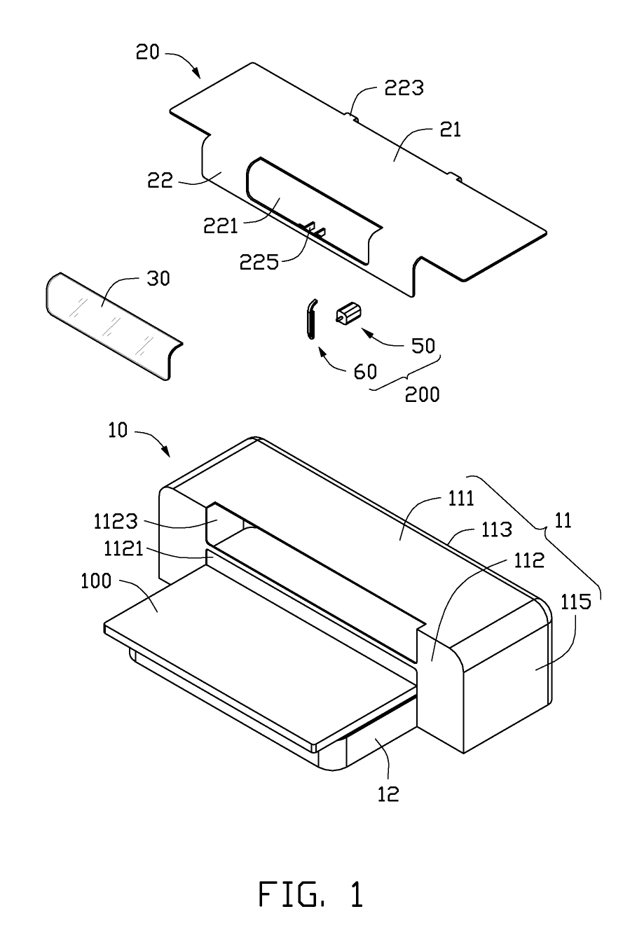

FIG. 1 shows a printer enclosure in accordance with an embodiment. The printer enclosure includes a enclosure 10, a cover 20, and a rear window 30.

The enclosure 10 includes a printing portion 11 and a paper tray 12 secured to a side of the printing portion 11. A plurality of printing members (not shown) are mounted in the printing portion 11. A paper 100 is printed in the printing portion 11 and then outputted on the paper tray 12.

The printing portion 11 includes a top plate 111, a front plate 112, a rear plate 113, and opposite two side plates 115. In one embodiment, the top plate 111 is substantially perpendicular to the front plate 112, the rear plate 113 and the two side plates 115, and the front plate 112 and the rear plate 113 are substantially perpendicular to the two side plates 115. The front plate 112 defines a first opening 1121 and a second opening 1123. The paper tray 12 is secured to the front plate 112. The paper 100 is outputted from the first opening 1121 and slid to the paper tray 12. The second opening 1123 is located above the first opening 1121 and extends to the top plate 111.

The cover 20 includes a flat plate 21 and a mounting plate 22 bent from a first side edge of the flat plate 21. The mounting plate 22 defines an installation opening 221 for mounting the window 30 therein. In one embodiment, the mounting plate 22 is substantially perpendicular to the flat plate 21. The cover 20 further includes two latching pieces 223 extending from a second side edge of the flat plate 21. The first side edge of the flat plate 21 is opposite and parallel to the second side edge of the flat plate 21. Two mounting pieces 225 are secured to an inner surface of the mounting plate 22. In one embodiment, the two mounting pieces 225 are substantially perpendicular to each other.

The window 30 is transparent, such as a glass and a plastic. The window 30 includes an arc-shaped portion (not labeled).

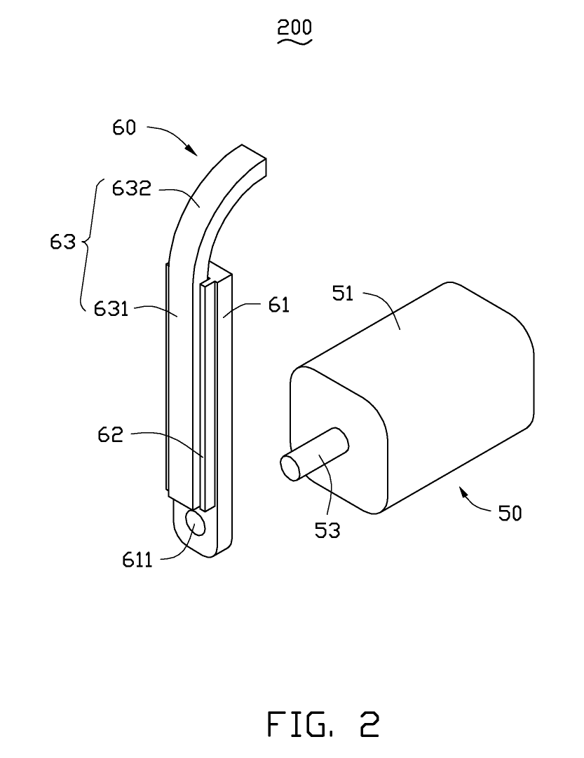

FIG. 1 and FIG. 2 show the printer enclosure further including a cleaning assembly 200. The cleaning assembly 200 includes a rotating member 60 and a motor 50.

The rotating member 60 includes an installation plate 61, two limiting pieces 62, and a rotating piece 63. The two limiting pieces 62 extend from the installation plate 61 and are substantially perpendicular to the installation plate 61. The rotating piece 63 includes an installation portion 631 and a bending portion 632. The installation portion 631 is engaged between the two limiting pieces 62. The bending portion 632 is bent from the installation portion 631 and is arc-shaped. The installation plate 61 defines a mounting hole 611. The mounting hole 611 is located below the two limiting pieces 62.

The motor 50 includes a driving portion 51 and a shaft 53. The driving portion 51 is capable of rotating the shaft 53.

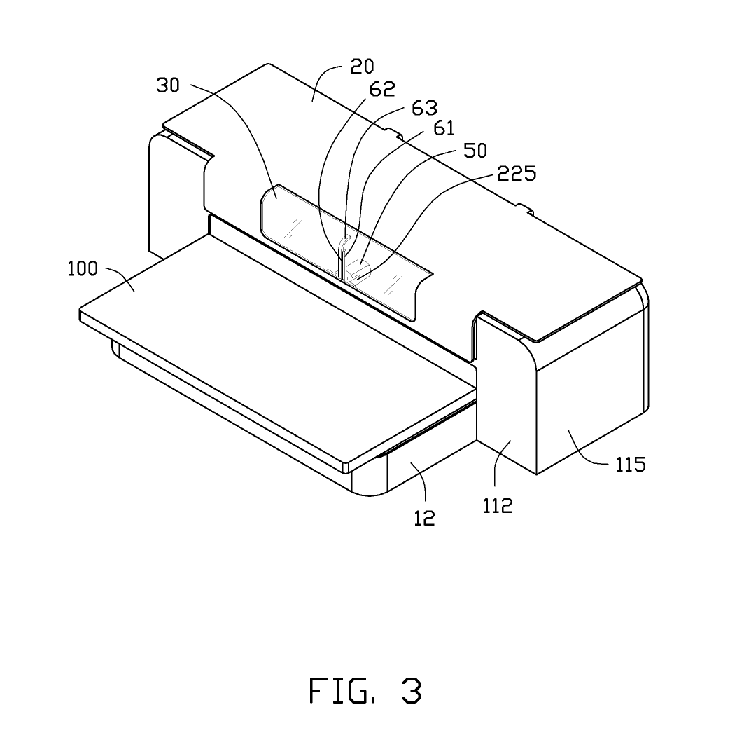

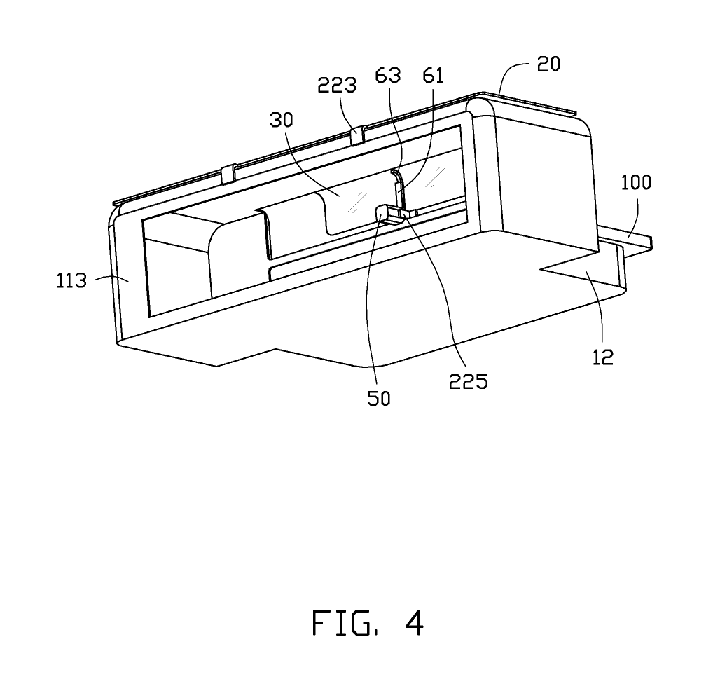

FIG. 3 and FIG. 4 show that, in assembly, the shaft 53 is engaged in the mounting hole 611, and the rotating member 60 is rotatable together with the shaft 53. The driving portion 51 is secured between the two mounting pieces 225. The window 30 is secured in the installation opening 221. The cover 20 is secured to the top plate 111 or the rear plate 113 by a common securing method, such as a screw. The rotating piece 63 abuts an inner surface of the window 30.

In another embodiment, the second opening 1123 can be defined in the top plate 111, the side plate 115, or the rear plate 113, so that the window 30 can be secured to the top plate 111, the side plate 115, or the rear plate 113.

In use, because the window 30 is transparent, users can see the paper 100 in the printing portion 11 through the window 30. Thus, if users spot a mistake on a picture printed on the paper 100 while printing, the users can stop the printing task immediately. Furthermore, users can locate the paper 100 is when the paper 100 is jammed, and users can locate printing members are when there is something wrong in printing.

Ink may be sprayed on the window 30 and diminishes visibility of the paper 100. In this situation, the motor 50 is worked to rotate the rotating member 60, and the rotating piece 63 scrapes the ink when the rotating member 60 is rotated.

It is to be understood, however, that even though numerous characteristics and advantages have been set forth in the foregoing description of embodiments, together with details of the structures and functions of the embodiments, the disclosure is illustrative only and changes ay be made in detail, especially in the matters of shape, size, and arrangement of parts within the principles of the disclosure, to the full extent indicated by the broad general meaning of the terms in which the appended claims are expressed.

What is claimed is:

1. A printer enclosure comprising:
a printing portion and a paper tray secured to a side of the printing portion; and the printing portion defines a printing space and an opening;
a cover secured to the printing portion and defining an installation opening; and
a window mounted in the installation opening and aligned with the opening;
wherein the printing space is visible through the window and the opening.

2. The printer enclosure of claim 1, further comprising a cleaning assembly, wherein the cleaning assembly is rotatably attached to the cover and abuts an inner surface of the window; and the cleaning assembly is rotatable relative to the window.

3. The printer enclosure of claim 2, wherein the cleaning assembly comprises a rotating member and a motor; the motor comprises a driving portion and a shaft connected to the driving portion; the rotating member is secured to the shaft, and it is the rotating member that abuts the window; and the driving portion is capable of rotating the shaft and the rotating member together.

4. The printer enclosure of claim 3, wherein the cover comprises two mounting pieces, the two mounting pieces are substantially parallel to each other, and the driving portion is secured between the two mounting pieces.

5. The printer enclosure of claim 3, wherein the rotating member comprises an installation plate, two limiting pieces, and a rotating piece; the installation plate defines a mounting hole; and the shaft is engaged in the mounting hole.

6. The printer enclosure of claim 5, wherein the two limiting pieces extend from the installation plate, and the rotating piece is secured between the two limiting pieces.

7. The printer enclosure of claim 5, wherein a part of the window has an arc-shape; the rotating piece comprises a bending portion; and the bending portion abuts the part of the window.

8. The printer enclosure of claim 1, wherein the printing portion comprises a top plate, a front plate, a rear plate, and two side plates; the top plate is substantially perpendicular to the front plate, the rear plate, and the two side plates; the front plate and the rear plate are substantially perpendicular to the two side plates; and the paper tray and the window are secured to the front plate.

9. The printer enclosure of claim 8, wherein the cover comprises a flat plate and a mounting plate extending from the flat plate; the mounting plate abuts the front plate; the flat plate abuts the top plate; and the window and the mounting plate cover the opening together.

10. The printer enclosure of claim 1, wherein the window is transparent and located above the paper tray.

11. A printer enclosure comprising:
a printing portion and a paper tray secured to a side of the printing portion; the printing portion is adapted to print a paper, and the paper tray is adapted to receive the paper after the paper is printed; the printing portion defines a printing space and an opening;
a cover secured to the printing portion and defining an installation opening;
a window mounted in the installation opening and facing the opening; and
a cleaning assembly rotatably attached to an inner surface of the window;
wherein the window is transparent, and the printing space is visible through the window and the opening; and the cleaning assembly is rotatable relative to the window, to scrape ink sprayed on the window.

12. The printer enclosure of claim 11, wherein the cleaning assembly is rotatably attached to the cover and abuts the inner surface of the window.

13. The printer enclosure of claim 11, wherein the cleaning assembly comprises a rotating member and a motor; the motor comprises a driving portion and a shaft connected to the driving portion; the rotating member is secured to the shaft, and it is the rotating member that abuts the window; and the driving portion is capable of rotating the shaft and the rotating member together.

14. The printer enclosure of claim 13, wherein the cover comprises two mounting pieces, the two mounting pieces are substantially parallel to each other, and the driving portion is secured between the two mounting pieces.

15. The printer enclosure of claim 13, wherein the rotating member comprises an installation plate, two limiting pieces, and a rotating piece; the installation plate defines a mounting hole; and the shaft is engaged in the mounting hole.

16. The printer enclosure of claim 15, wherein the two limiting pieces extend from the installation plate, and the rotating piece is secured between the two limiting pieces.

17. The printer enclosure of claim 15, wherein a part of the window has an arc-shape; the rotating piece comprises a bending portion; and the bending portion abuts the part of the window.

18. The printer enclosure of claim 11, wherein the printing portion comprises a top plate, a front plate, a rear plate, and two side plates; the top plate is substantially perpendicular to the front plate, the rear plate, and the two side plates; the front plate and the rear plate are substantially perpendicular to the two side plates; and the paper tray and the window are secured to the front plate.

19. The printer enclosure of claim 18, wherein the cover comprises a flat plate and a mounting plate extending from the flat plate; the mounting plate abuts the front plate; the flat plate abuts the top plate; and the window and the mounting plate cover the opening together.

20. The printer enclosure of claim 11, wherein the window is transparent and located above the paper tray.
